(19) United States
(12) Patent Application Publication
(10) Pub. No.: US 2012/0026007 A1
(43) Pub. Date: Feb. 2, 2012

(54) Utility Meter and Method of Operation

(75) Inventor: Eric Beattie, Kinross (GB)

(73) Assignee: Utility Metering Services Limited, London (GB)

(21) Appl. No.: 13/255,070

(22) PCT Filed: Mar. 6, 2009
(86) PCT No.: PCT/GB2009/000632

§ 371 Date: Oct. 17, 2011

(51) Int. Cl. G08C 15/06

(52) U.S. Cl. 340/870.02

(57) ABSTRACT

Utility meter for monitoring, recording and communicating commodity consumption data at a customer site, comprising: a meter unit (9, 10) for recording said consumption data and generating a meter output signal being representative of said consumption data; a processor unit (4, 17) for processing said meter output data and for providing at least one evaluation value; a memory unit (6) for storing said meter output data and/or said at least one evaluation value; a communications unit (7, 8, 15) for transmitting said evaluation value to a utility supplier and for receiving evaluation parameters from said utility supplier, characterized by a power supply converter unit (3, 12) for converting external electric power into internal electric power for the supply of said meter unit, processor unit, memory unit and communications unit, which power supply converter unit is self-adjusting to an external electric power input voltage.

The invention relates to a utility meter for monitoring, recording and communicating resource consumption data at a customer site and with the capability of an automatic remote read-out. The concerning resources are electricity, gas and water.

Since nowadays practically all houses are connected to the public networks of electricity and gas and water supply the consumption of these utilities must be monitored and recorded for billing. These monitoring and recording operations are carried out by meters at the customer sites on the respective customer premises. For read-out of the meters a utility supplier agent must enter the premises usually once per billing interval. Such manual read-out is associated with high costs; long distances have to be covered by the agents; some customers may not be available at the agreed time or may even refuse access to their premises; the read-out of meters that are dispersed in wider areas spreads over a considerable period of time so that billing has to be effected for each customer individually and can not be carried out for all customers at the same time.

Hence, it is undisputed that a remote read-out of meters rendering visits to customer sites obsolete would be advantageous for both the consumer and the supplier. However, from replacing or retrofitting already existing devices at the customer sites high costs ensue for the supplier companies since the numbers of existing devices lie in the thousands or tens of thousands for a single supplier in each area.

Moreover when the existing meters are subject to a retrofit all suboptimal aspects should be considered and amended at the same time in order to save installation costs. E.g. accuracy in measuring power usage may be improved. The accuracy standard for conventional mechanical watthour meters is +2%. Conventional mechanical meters sense rotation of a mechanical rotating ring and convert the sensed rotations to digital signals to indicate the corresponding power usage. Electronic sensing of current and voltage for the calculation of power has also been proposed for electronic watthour meters. Such sensing circuits have been specifically designed for use in a specially designed electronic watthour meter. However, little attention has been paid in such single phase watthour meters for accurately measuring power consumption.

Another factor which may be improved with existing meters is the desirability of having time of day and demand power control by the utility company at residential locations. A meter that records also the time of day would allow more variable billing approaches by utilities including time of day billing where varying rates are applied to electrical usage at different periods during each 24 hour day. Also demand or peak billing would become feasible where the amount of power consumed is billed at a higher rate for power usage exceeding a predetermined amount. For such billing approaches accurate power consumption data must be available in order to determine the peak load of any customer and the power usage during any time of day period.

Still another factor is the flexibility the meter should have if the utility supplier as its proprietor is active on various markets with different technical requirements. In particular with regard to the requirements of the electric power grid in different countries there may be unequal conditions as to the voltage. For instance the voltage in most European countries is 230 VAC, whereas the voltage in North America is 120 VAC. It would thus be desirable to have a meter that fits to both systems without any extra manual adjustment. However, the meter converts physical parameters like current and flow of a medium into electric signals and buffers the electric signals in an onboard memory. Hence, usually the electric power supply of the meter itself must be adapted to its respective application.

Thus, it would be desirable to provide a utility meter device that is devised for installation at any customer site which overcomes the problems of prior art utility meter devices. It would also be desirable to provide a utility meter device which is usable with differing power grids without requiring manual modifications to the meter itself or the meter socket.

It would still be desirable to provide a utility meter device which utilizes data communication via RF communications channels with either a remote in-house control or a central utility site.

An extensive analysis of available smart meters revealed that currently no product is available which satisfies those basic needs that were recognized by the inventor. The existing devices suffered—inter alia—from the following shortcomings. Meter electronics are poorly designed and consume excessive power which can be directly translated into carbon generated. Current non-smart meters consume around 6 kilowatts per annum which translates to around 3 kg of carbon. Current Smart meters generate approximately double this. This is unacceptable in today's eco friendly environment.

Further, as to their flexibility current meters tend to support one function, that is they are either credit meters or pre-payment meters. This is inappropriate in today's consumer orientated world. A meter should be capable of performing all functions including the new (as yet un-established) Pay As You Go offering which should be similar to the mobile phone world.

With regard to communications any new meter must be able to support numerous communications technologies to allow for differentiation in this increasingly commercial world. All current smart meters are based on available non-smart meters which have had communications ‘bolted on’. This provides a poor unreliable platform only.

Moreover, there are serious drawbacks concerning human interface of the current meters: in general only basic information is displayed. A true smart meter must provide all the information required in a multifunction meter in a clear and concise way.

It is the object of the present invention to overcome all those prior art deficiencies.

As a first aspect of the invention there is provided a utility meter device according to claim 1. As a second aspect a method of operating such meter is provided according to claim 18.

The basic principle of the invention is a new design of the utility meter power supply that enables the application of the meter under various conditions. To that order the utility meter comprises a power supply unit which adapts itself to the actual parameters of the external power supply. This is achieved by a switched mode power supply which uses PWM for control. With this design the power supply of the meter is self-adapting to the voltage of an external electric power.

Hence, according to the invention there is provided a utility meter for monitoring, recording and communicating commodity consumption data at a customer site, comprising:

a meter unit for recording said consumption data and generating a meter output signal being representative of said consumption data;
a processor unit for processing said meter output data and for providing at least one evaluation value;
a memory unit for storing said meter output data and/or said at least one evaluation value;
a communications unit for transmitting said evaluation value to a utility supplier and for receiving evaluation parameters from said utility supplier, that is characterized by
a power supply converter unit for converting external electric power into internal electric power for the supply of said meter unit, processor unit, memory unit and communications unit, which power supply converter unit is self-adjusting to an external electric power input voltage.

Preferably the utility meter device embodies one or—if technically feasible and advantageous—multiple of the following features:
said commodity is gas and said external electric power is provided by a battery;
said commodity is electric power and said external electric power is provided by the mains;
said power supply converter unit is a switched mode power supply;
said communications unit comprises an element from the group based on IEEE802.11 standards such as WiFi, WIMAX, HSPA, UMTS, GSM, GPRS, WLAN;
said communications unit is a GSM unit for transmitting and receiving voice messages and/or sms-messages;
said communications unit is a WLAN unit for transmitting and receiving data under TCP/IP protocol;
a second communications unit is provided for in-house remote control and monitoring from the group based on IEEE802.15 standards such as Bluetooth and Zigbee;
said second communications unit is a Zigbee unit;
a supply disconnect is provided for disconnecting said customer site from supply upon receipt of a disconnect signal through said first and/or second communications unit;
said disconnect signal is generated when consumption data exceed a predetermined credit value;
said memory includes a credit value sub-unit for storing said credit value and said processor includes a countdown register for counting down a utility volume or money units (prepayment meter);
said credit value is loaded in said credit value sub-unit from outside through said first and/or second communications unit;
said utility meter for electric power is powered by said mains;
said utility meter for gas meter and/or water meter is powered by an element from the group consisting of a battery, in particular rechargeable battery, and an energy scavenger (harvester);
a display unit for displaying said meter output signal and/or said at least one evaluation value is provided;
a power supply management unit is provided for activating said processor unit upon an external activation signal.

The corresponding method of operating such meter comprises:

recording said consumption data and generating a meter output signal being representative of said consumption data by a meter unit;
processing said meter output data and providing at least one evaluation value by a processor unit;
storing said meter output data and/or said at least one evaluation value by a memory unit;
transmitting said evaluation value to a utility supplier and receiving evaluation parameters from said utility supplier by a communications unit,
with the additional steps of
detecting physical parameters for quantification of said commodity; and
calculating said at least one evaluation value based on said detected physical parameters.

In a first preferred implementation said commodity is gas and said physical parameters comprise gas volume.

In a second preferred implementation said commodity is electric power and said physical parameters comprise voltage and electric current.

It is a particular advantage of the utility meter according to the invention that it is highly efficient, and hence consumes much less power than comparable meters in the prior art. Another particular advantage of the meter is that the voltage range over which proper regulation on the supplies can be maintained is from 80VAC to around 350VAC, which covers practically all requirements worldwide as to mains voltages.

Other features and advantages of the utility meter according to the invention will be understood from the following description of particularly preferred embodiments of the invention—by way of example only—with reference being made to the accompanying drawing in which

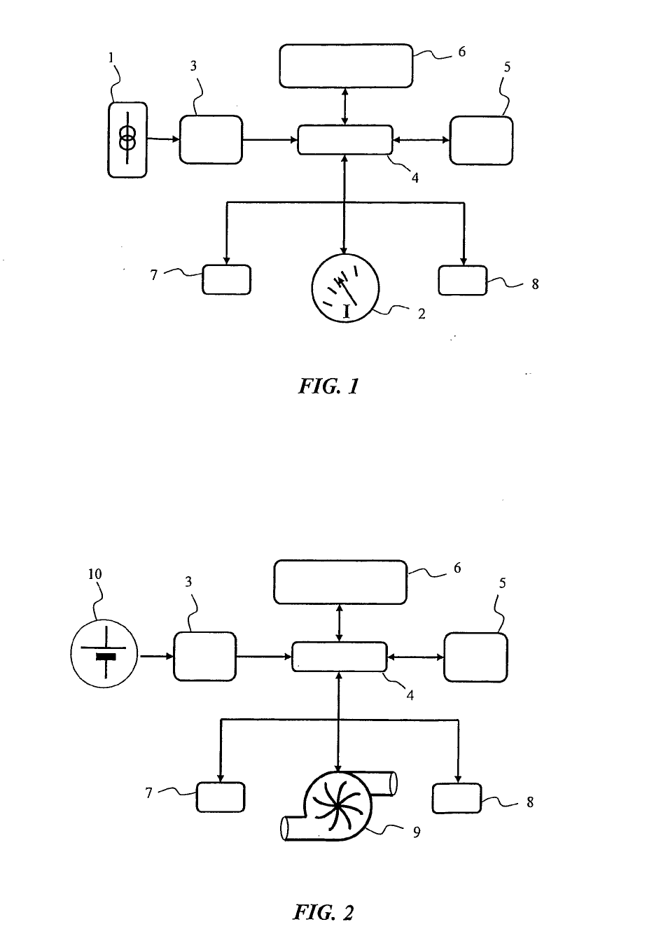

FIG. 1 shows a block diagram of an electricity utility meter according to the invention;

FIG. 2 shows a block diagram of a gas utility meter according to the invention;

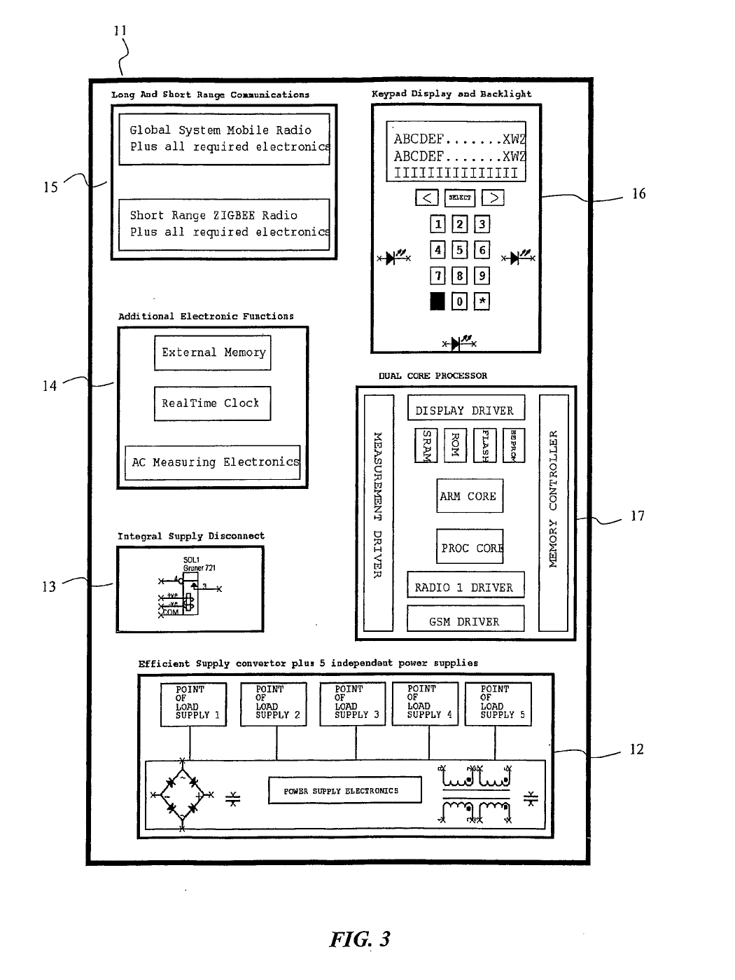

FIG. 3 shows a block diagram of utility meter components according to the invention;

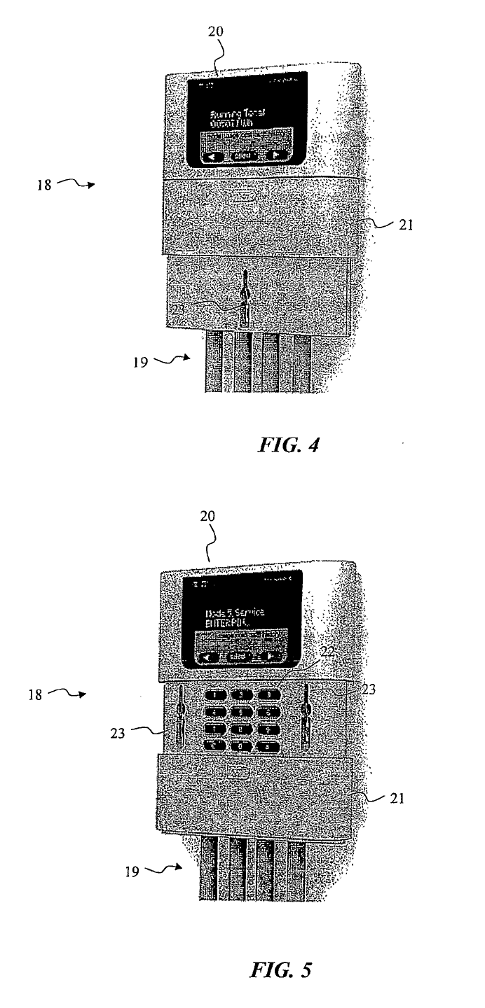

FIGS. 4 and 5 show a meter housing according to the invention.

In the Figures same or equivalent elements are referenced with the same numerals unless otherwise stated.

In FIG. 1 shows a schematic block diagram of a solid-state electricity meter. The electricity meter controls the consumption of devices (not shown) that are attached to a mains input 1. This control may be responsive to a credit that is allowed to the customer, and the remaining credit is continually updated as consumption increases.

An electric current meter unit 2 detects the actual consumption of the attached devices. To that order current sense means are coupled to the electrical power conductors for sensing the instantaneous current of the electrical load voltage sense means are also coupled to the power conductors. The electric current meter unit 2 usually samples voltage and current waveforms and extracts therefrom both the actual power consumption and the “quality” of the used power, i.e. how good voltage and current waveforms are in-phase. In detail the electricity element 2 firstly measures and digitizes, respectively, the amplitude of the mains voltage. Although the voltage is fairly constant either at 230VAC or at 120VAC, it can vary by as much as 10% depending on the overall load. Hence, for a high accuracy power measurement it is crucial that the voltage amplitude is precisely measured. Secondly, the meter measures the electric current that flows through the in-house devices. The product of current and voltage represents the power consumption. However, that is valid exactly only if current and voltage are in-phase. Otherwise the product of current and voltage represents the real component of electric power only. In general only this real component of power is considered in a domestic meter. In addition to the real power the meter in FIG. 1 also measures the reactive power that is due to a phase difference between voltage and current. For appraisal of this reactive power, not only the amplitude of both current and voltage is taken into account individually, but also their relative phase difference. A processor, which will be discussed later, executes a software program for integrating the digitized voltage and current values over time and to store the resulting consumption values in a memory. Consequently the meter in FIG. 1 allows for measurements with accuracy better than 0.25%, whereas prior art meters can exhibit an inaccuracy of over 2% ensuing billing impreciseness in the order of some 10's of Euros per month. Hence, a true reading of power consumption is accomplished.

Preferably the electric current is physically sensed by using a planar Rogowski coil (not shown). Although this kind of sensor is delicate as to its EMC characteristics it has proven to be most appropriate in terms of accuracy. Provision of a comparatively large margin may compensate the sensor sensitivity to EMC interferences. On the other hand a planar Rogowski coil shows the benefit of improved immunity to magnetic fields, so that defraud of the electricity meter using powerful magnets becomes considerably difficult.

The electronics (not shown) for sampling and evaluating the waveform of mains voltage and mains current need electric supply for themselves. Hence a power converter unit 3 is part of the meter for providing electricity to the meter unit 2 and other meter components that will be discussed below. The power converter unit 3 taps the mains and converts the mains voltage into a supply voltage for the electronic components of the meter, i.e. 4V, 12V etc. with an appropriate amperage.

Since the meter is supposed to work both on 230VAC and 120VAC power grids in a “plug-and-play” fashion, i.e. without necessitating special manual adaptation to the actual environment, the internal power supply is supposed to adjust itself to the mains voltage automatically. To that order the power converter unit 3 of the meter internal power supply is a switch mode flyback power supply, which uses output feedback to maintain a constant output on all supplies. As this technique uses PWM for control, the voltage range over which proper regulation on the supplies can be maintained is from 80VAC to around 350VAC, which amply covers all realistic requirements for a meter. The power supply control is automatic, with the feedback circuits completely regulating the PWM controller and hence the supply.

In summary, the power converter unit 3 comprises not only a power supply but also a dedicated power management. This power supply management unit can be used for activating the meter processor unit upon receipt of an external activation signal and for deactivating the meter electronics, except for the gas and electricity meter itself, otherwise.

Sampling and evaluation of the measurement data may be performed by a multi-purpose processor of a microprocessor unit 4. The multi-purpose processor may be e.g. an ARM processor that is particularly tailored for mobile electronics and is outstanding with regard to its low power consumption. Hence, such an ARM processor is well suited for the present application in a utility meter. In addition to the actual processor the microprocessor unit 4 may comprise further electronic components which are necessary or useful for preparing output signals of the detectors and for evaluating and communicating calculation results. Some of these electronic components will be described further below.

A particular element of the meter is a memory unit 5. Since the meter is not continually polled or does not transmit its data in a continuous fashion to the requesting utility, resulting data have to be buffered temporarily. For this purpose said memory unit 5 is provided that may incorporate EEPROMs, flash-EEPROMS, FeRAMs and other suitable memory circuits. Irrespective of the particular memory it is essential that its contents are save also when the power of the meter is down. Only then it is guaranteed that the consumption data concerning the past, i.e. before an incidental power-down, are not lost but can still be retrieved from the meter, also at a later time.

At the same time the sensed voltage and current data may be displayed on a display 6 of the meter, together or alternate with resulting items as calculated by the processor unit 4 such as the current total, the remaining credit, details on consumption and idle periods or other items. In order to allow the user interactions with the meter and to select either sensed or evaluated data for display the display unit 6 may also comprise a keypad on which the user may enter instructions to the meter. It will be appreciated that the corresponding instruction set will include only commands that do not alter the contents of the memory unit 5. Under all circumstances the contents of the memory unit 5 are locked in the memory unaccessible for the user and may only be reset or updated and programmed by the utility, preferably from remote via a communications channel to be detailed below. Hence, the instructions that are available for the user concern the various display modes of the display unit 6 instead of any access to the memory unit 5.

As to the communication of the consumption data there are two communications channels provided according to the invention. First, a long range communications unit 7 is part of the meter that is preferably based on any one of the various GSM standards. Through this channel the utility can poll the meter and read out consumption data without having to enter the customer's premises. In particular a communications protocol is executed by the processor unit 4 and from the utility site in regular time periods the consumption values are interrogated from the meter. The protocol offers additional options like voltage or current limits. Further update services like adaptation of the current energy price or warnings as to the consumption rate may be transmitted from the utility to the meter and so the user is timely informed of any changes to his contract. The physical layer of the long range unit 7 is preferably based on a IEEE802.11 standard and may incorporate WiFi, WIMAX, HSPA, UMTS, GSM, GPRS, and WLAN. In particular messages may be exchanged between utility and meter as automated voice messages or sms-messages. Also WLAN communication under TCP/IP protocol is an appropriate option for long-range communications.

Yet, on the other hand it is also very convenient for the customer if data from the meter, which is usually located at a rather remote place in the house, are transferred to e.g. the living room or dining room of the house. Here a display unit (not shown) in one of the respective rooms in the house may receive the data from the meter and display it so that the information is immediately available to the customer and need not be checked by him/her in regular time intervals from the—offside—meter. Hence, in accordance with the invention, the meter also supports a short-range communications technique apart from the long-range communications technique. Such short-range technique is covered by an associated short-range unit 8. Moreover, the meter is capable of converting to other techniques as and when cost or technical reasons dictate. Examples for such short-range communications standards for in-house remote control and monitoring are IEEE802.15 standards such as Bluetooth and Zigbee. In practice, however, Zigbee has proven to be most appropriate for the short-range purpose.

It will be understood by a person skilled in the art that the above meter is not restricted to measuring electricity, yet is also applicable to measuring e.g. gas consumption or water usage. A meter for gas consumption for example differs only in few elements from the corresponding electricity meter. A gas meter is shown in FIG. 2. The two elements in which the gas meter according to the invention differs from the electricity meter in FIG. 1 are a gas flow sensor 9 that replaces the corresponding electric current meter 2 and the electric power source. The gas flow sensor is indicated as a turbine wheel. Since it is mandatory that the gas meter does not ignite if there is a leak there are particular requirements as to the gas meter power source. If the gas meter were powered by mains there would be practically no limit for the electric current from the power source. This however could entail a series of sparks igniting the gas with disastrous impact. For this reason a battery 10 is used as an electric power source instead of the mains, since the battery voltage breaks down almost immediately after a short circuit has occurred. In particular the battery can be rechargeable.

Instead of any such battery 10 also a very different type of power supply could be used that is also safe in terms of ignition and explosion. Such power supply could be an energy scavenger (harvester) that exploits all kinds of vibrations that inevitably occur upon transportation of masses and transforms them into electric energy. This energy can then be used to run the meter.

As to the other elements the embodiment of FIG. 2 resembles the one of FIG. 1, and the rest of the elements will not be discussed here again for sake of brevity. The basic principle of the data retrieval and evaluation is in both cases identical, however, it will be appreciated that with a gas meter only the number of revolutions per time interval will be detected instead of voltage and electric current with the above electricity meter. Hence, there is no need to take into account any other measured variable and to distinguish between real and reactive items.

The core elements of the meters in FIGS. 1 and 2 are depicted in a basic set-up 11 of them meter in FIG. 3. The basic set-up 11 comprises a meter power supply 12 including a transformer, a bridge rectifier circuit, and power supply electronics for feeding several load supply points, five of which are shown in FIG. 3.

As a security measure an integral supply disconnect 13 is provided which interrupts the power supply in case of an emergency in order to prevent the meter from being destroyed if there is an excess voltage or a short circuit with a large current flowing. As an alternative, the supply disconnect, i.e. power switch 13 disconnects the customer site from supply upon receipt of a disconnect signal from outside. The disconnect signal may be received by the meter e.g. through the long-range or short-range communications channel and the respective meter components 7, and 8.

As still another alternative the disconnect signal is generated when consumption data exceed a predetermined credit value. In this case the utility meter includes a dedicated memory for storing a credit value that is granted to the customer by the utility. The processor includes a countdown register for counting down the credit by utility volume or money units (prepayment meter). It will be appreciated that the credit value is loaded from the utility into the credit value memory from outside through one of the respective communications units 7 and 8.

In a block 14 additional electronic functions are pooled together such as a clock unit and some external memory for e.g. an operating system. However, most important, in block 14 there is the AC measuring electronics located which samples the mains voltage and current waveforms. On the basis of the sampled data the actual consumption is calculated then under consideration of phase differences between voltage and current as the case may be.

The data output by block 14 are processed in a processor unit 17 with appropriate driver circuits, onboard memory circuitry and the processor itself. Attributes and parameters as well as the results of evaluation operations that are performed by the processor unit 17 are displayed in a display unit 16, which also includes a keypad for receiving instructions entered by the customer and for maintenance purposes. The display comprises a display screen in conjunction with said keypad and some additional indicators, which are depicted as LEDs.

For establishing a long-range and/or short-range communications channel a communications interface board 15 is provided. The interface board 15 accommodates 2G and 3G GSM electronics for polling consumption data by the utility as well as electronics for in-house communication such as ZigBee.

The meter is accommodated in a new housing 18 that is shown in FIGS. 4 and 5. In FIG. 4 the housing 18 is shown in a closed status. Several mains lines 19 enter the housing 18 from below. A display 20 is located in the upper part of the housing so that it is easy to discern for a user. Below the display 20 there is a sliding cover 21 that overcasts a keypad underneath.

The housing 18 is shown in its open status in FIG. 5. Contrary to FIG. 4 the sliding cover 21 is pulled down in FIG. 5 and reveals a keypad 22. On the keypad access codes etc. may be entered in order to change the display or carry out maintenance work. In order to make the housing tamper-proof seals 23 are provided on the housing, which would give evidence of any attempt to open the housing 18.

With the above meter according to the invention and its new design philosophy a reliable low cost, low carbon communications platform and configuration of this platform has been achieved that allows accurate measurement of energy flow; be it electricity or gas or water. The platform is similar to that of a mobile phone, although instead of Bluetooth like in mobile phones for short range communications the platform according to the invention uses preferably ZigBee, which is the communications of choice for smart metering.

Although the subject of the above specification is an electricity/gas smart meter, it is clear that the design philosophy lends itself to other metering, and any other, as yet unidentified, smart utility products.

In order to produce a low cost, low carbon meter, the following design steps were taken: a common gas/electricity/utility display is used, a common gas/electricity/utility processor is used, a common gas/electricity/utility memory is used, common power management circuits are used, and common communication devices are used. Yet, the electricity measurement circuits and the meter enclosure have been newly developed for the electricity meter. The smart core of the electricity meter was applied then also to the new gas meter. So in both cases, electricity and gas, the man machine interface has proven to give most satisfactory results as to function and ease of use. Especially hiding the keypad behind a sliding door is a unique feature of the design. By the new housing design and the novel mechanism height constraints can be easily complied with.

In summary the utility meter according to the invention comprises a meter unit 9, 10 for recording consumption data like electricity or gas and generating a meter output signal that is representative of the consumption data. It further comprises a processor unit 4, 17 for processing the meter output data and for providing at least one evaluation value. A memory unit 6 is provided for storing the meter output data and/or evaluation value(s). The evaluation value is then transmitted to a utility supplier, and evaluation parameters are received from said utility supplier by a communications unit 7, 8. In addition to theses known components a power supply converter unit 3, 12 is provided for converting external electric power into internal electric power for the supply of said meter unit, processor unit, memory unit and communications unit. The power supply converter unit is self-adjusting to an external electric power input voltage.

This makes the meter apt for different countries. When designing an electricity meter, it is normal to design the product for a country it is intended for, that is, one country it will operate at 230VAC at maximum 100 AMPS, and for another country it will operate at 120VAC at maximum 200 AMPS. Further the accuracy requirements are different in different countries. Therefore it is easier to make a meter solely for one country.

However, with the meter according to the invention the electronics can operate in all countries without modification, as the unit automatically adjusts itself to any voltage, and meets the accuracy requirements worldwide for domestic meters.

Although the meter enclosure may have to be changed for individual countries, the electronic meter core can operate anywhere without adjustment. Moreover, the core design of this product is common to any utility meter, so with minimum hardware changes, (i.e. changing the power supply to operate with a battery for a gas or water meter for instance) a different energy source can be measured. That is, the structure of the software is common to all utility supplies.

The operation of such meter may be summarized as follows.

The consumption data are recorded and a meter output signal is generated that is representative of the consumption data. Thereafter the meter output data are processed by a processor unit so as to give at least one evaluation value that is characteristic of the used resource. The at least one evaluation value is stored by a memory unit, and also meter output data may be stored in the memory. Additionally, the evaluation value is transmitted to a utility supplier and evaluation parameters may be received from said utility supplier via a communications unit. In order to calculate the evaluation value physical parameters are detected that are characteristic for quantification of said resources. The at least one evaluation value is then calculated based on said detected physical parameters.

If the resource is gas, the characteristic physical parameter is the volume of gas that flows through the meter. If the resource is electric power, the corresponding physical parameters comprise voltage and electric current.

The invention is not limited to the above outlined embodiments but encompasses all meters, which are based on the general principle as claimed in the claims. For example, it should be clear, that the electricity meter is applicable for three wire single phase and for three phase electric power grids. Further deviations from the above embodiments that are still within the scope of the claims will be obvious to a person skilled in the art.

### REFERENCE NUMERALS

1 mains
2 electric current meter unit
3 power converter unit
4 microprocessor unit
5 memory unit
6 display driver unit
7 long range radio unit
8 short range radio unit
9 gas flow meter unit
10 battery
11 meter
12 meter power supply
13 supply disconnector
14 preprocessing electronics
15 communications interface
16 display and input board
17 microprocessor unit
18 meter housing
19 mains lines
20 display
21 sliding cover
22 keypad
23 seal

1. A utility meter for monitoring, recording and communicating commodity consumption data at a customer site, comprising:
a meter unit for recording said consumption data and generating a meter output signal being representative of said consumption data;
a processor unit for processing said meter output data and for providing at least one evaluation value;
a memory unit for storing said meter output data and/or said at least one evaluation value;
a communications unit for transmitting said evaluation value to a utility supplier and for receiving evaluation parameters from said utility supplier; and
a power supply converter unit for converting external electric power into internal electric power for the supply of said meter unit, processor unit, memory unit and communications unit, which power supply converter unit is self-adjusting to an external electric power input voltage.

2. The utility meter according to claim 1, wherein said commodity is gas and said external electric power is provided by a battery.

3. The utility meter according to claim 1, wherein said commodity is electric power and said external electric power is provided by the mains.

4. The utility meter according to claim 3, wherein said power supply converter unit is a switched mode power supply.

5. The utility meter according to claim 1, wherein said communications unit comprises an element from the group based on IEEE802.11 standards including any of WiFi, WIMAX, HSPA, UMTS, GSM, GPRS, and WLAN.

6. The utility meter according to claim 5, wherein said communications unit is a GSM unit for transmitting and receiving voice messages and/or sms-messages.

7. The utility meter according to claim 5, wherein said communications unit is a WLAN unit for transmitting and receiving data under TCP/IP protocol.

8. The utility meter according to claim 1, wherein a second communications unit is provided for in-house remote control and monitoring from the group based on IEEE802.15 standards including any of Bluetooth and Zigbee.

9. The utility meter according to claim 8, wherein said second communications unit is a Zigbee unit.

10. The utility meter according to claim 1, wherein a supply disconnect is provided for disconnecting said customer site from supply upon receipt of a disconnect signal through said first and/or second communications unit.

11. The utility meter according to claim 10, wherein said disconnect signal is generated when consumption data exceed a predetermined credit value.

12. The utility meter according to claim 11, wherein said memory includes a credit value sub-unit for storing said credit value and said processor includes a countdown register for counting down a utility volume or money units (prepayment meter).

13. The utility meter according to claim 12, wherein said credit value is loaded in said credit value sub-unit from outside through said first and/or second communications unit.

14. The utility meter according to claim 1, wherein said utility meter for electric power is powered by said mains.

15. The utility meter according to claim 1, wherein said utility meter is powered by an element from the group consisting of a battery, in particular rechargeable battery, and an energy scavenger (harvester).

16. The utility meter according to claim 1, wherein a display unit for displaying said meter output signal and/or said at least one evaluation value is provided.

17. The utility meter according to claim 1, wherein a power supply management unit is provided for activating said processor unit upon an external activation signal.

18. A method of monitoring, recording and communicating commodity consumption data at a customer site with a utility meter, comprising:
recording said consumption data and generating a meter output signal being representative of said consumption data by a meter unit;
processing said meter output data and providing at least one evaluation value by a processor unit;
storing said meter output data and/or said at least one evaluation value by a memory unit;
transmitting said evaluation value to a utility supplier and receiving evaluation parameters from said utility supplier by a communications unit;
detecting physical parameters for quantification of said commodity; and
calculating said at least one evaluation value based on said detected physical parameters.

19. The method according to claim 18, wherein said commodity is gas and said physical parameters comprise gas volume.

20. The method according to claim 18, wherein said commodity is electric power and said physical parameters comprise voltage and electric current.
